(19) United States
(12) Patent Application Publication
(10) Pub. No.: US 2007/0242092 A1
(43) Pub. Date: Oct. 18, 2007

(54) Ink jet Printhead Control Circuit

(75) Inventors: Wei-Fu Lai, Taichung City (TW); Fu-Sheng Huang, Hsinchu City (TW); Francis Chee-Shuen Lee, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: INTERNATIONAL UNITED TECHNOLOGY CO., LTD., Hsin-Chu (TW)

(21) Appl. No.: 11/624,216

(22) Filed: Jan. 18, 2007

(30) Foreign Application Priority Data
Apr. 14, 2006 (TW) 95113335

(51) Int. Cl. B41J 29/38

(52) U.S. Cl. 347/9

(57) ABSTRACT

An ink jet printhead control circuit is provided. The ink jet printhead control circuit includes at least a nozzle firing circuit and a nozzle firing control circuit. The nozzle firing circuit includes a switch and a heating resistor. The switch and the heating resistor are coupled in series between a power voltage level and a predetermined voltage level. The nozzle firing control circuit is electrically coupled to the nozzle firing circuit, and receives a selection signal and an address signal. When the address signal and the selection signal are enabled, the nozzle firing circuit is controlled to apply the power voltage level to turn on the switch to drive the heating resistor so that droplets of ink are jetted out.

### CROSS-REFERENCE TO RELATED APPLICATION

This application claims the priority benefit of Taiwan application serial no. 95113335, filed Apr. 14, 2006. All disclosure of the Taiwan application is incorporated herein by reference.

### BACKGROUND OF THE INVENTION

1. Field of Invention

The present invention relates to an ink jet printhead circuit. More particularly, the present invention relates to an ink jet printhead control circuit.

2. Description of Related Art

Computers are widely used in the present era. In addition to displaying data or images processed by the computer on the display, there are several ways to output data or images. A printer is one of the most common output devices which can output texts, data, graphics, etc. on the papers or other kind of medium.

Current printers can be substantially classified into three types, namely dot matrix printers, ink jet printers, and laser printers. Each of these three printers has its own advantages. Users can choose printers based on their need.

Taking an ink jet printer as an example, a cartridge installed in a printer can contain ink with one or more different colors. The cartridge jets out the drops of ink via the nozzles onto the paper or other kind of medium to form texts, lines, or graphics.

FIG. 1 is an ink jet drive circuit disclosed in the U.S. Pat. No. 6,299,292. As shown in FIG. 1, the drive circuit includes 16 printhead arrays 105. Each printhead array 105 includes 13 heating resistors (heaters) H. After the decoder 109 receives the print command, it will send out the address decoding signal of the printhead based on the print command to heat up the heaters H corresponding to the specific addresses so that the ink will be heated and jetted out via the nozzle.

The decoder 109 sends out the printhead array address signals AD1-AD16 and the heater address signals A1-A13. The printhead array address signals AD1-AD16 will determine which printhead array 105 will be driven. The heater address signals A1-A13 will determine which heater H in the specific printhead array 105 will heat the ink. The first terminal of the heater H receives the voltage signal V and the second terminal of the heater H will be controlled by two switches to determine whether current passes through that heater. These two switches comprise field-effect transistors 101 and 103. The gate of the field-effect transistor 103 receives the printhead array address signal; the source (when the field-effect transistors is a CMOS) receives the heater address signal. When the source and the gate of the field-effect transistor 103 are enabled at the same time, the drain (when the field-effect transistor is a CMOS) will generate current signal and send it to the gate of the field-effect transistor 101. The source-drain of the field-effect transistor 101 will then be turned on when the voltage signal V is supplied, and the heater H will heat the ink and the ink is ready to be jetted out.

FIG. 2 is the ink jet drive circuit disclosed in the U.S. Pat. No. 5,867,183. As shown in FIG. 2, the ink jet drive circuit includes the ink jet printhead drive unit 201 and the printhead ink output units 211 and 213. The ink jet printhead drive unit 201 includes the ink jet printhead drive circuit 203 and the printhead selection circuit 205. The ink jet printhead drive circuit 203 outputs a set of bus control signals 207 and the printhead selection circuit 205 outputs a set of bus selection signal 209 selectively to enable one of the printhead ink output units. The control signals 207 and the corresponding selection signal will determine whether to enable the nozzles of one of the printhead ink output units.

The printhead ink output unit 211 includes the enable circuit 215, nozzle firing circuits 225-231 and the nozzle 233. The enable circuit 215 includes a plurality of field-effect transistors 217, 219, 221 and 223. The drain (current input) of each field-effect transistor will receive the corresponding control signal in the bus control signal set 207. The gate (command input) of each field-effect transistor will receive the corresponding selection signal in the bus selection signal set 209. When the drain and the gate of the same field-effect transistor are enabled at the same time, the source (output terminal, current output) will generate a current signal to drive the coupled nozzle firing circuit. For example, the field-effect transistor 217 is coupled to the nozzle firing circuit 225 and the field-effect transistor 219 is coupled to the nozzle firing circuit 227. Then the nozzle firing circuit will jet out the ink out of the nozzle 223. The operating principle of the other printhead ink output unit 213 is the same as that of the above mentioned printhead ink output unit 211.

However, because the transistors 217, 219, 221, and 223 are coupled between the nozzle firing circuit and the bus, a body effect of the transistors occurs, which causes a low drive level received by the nozzle firing circuit and delays ink jetting. Furthermore, such circuit architecture adopts the address signals to drive the heating resistors, and thus the address signals require a larger driving force to drive the nozzle 233.

### SUMMARY OF THE INVENTION

An objective of the present invention is to provide an ink jet printhead control circuit which is capable of reducing the ink jetting delay, increasing the drive level, and improving the ink-jet performance.

Other objectives, features and advantages of the present invention will be further understood from the further technology features disclosed by the embodiments of the present invention wherein there is shown and described a preferred embodiment of this invention, simply by way of illustration of one of the modes best suited to carry out the invention. As it will be realized, the invention is capable of different embodiments, and its several details are capable of modifications in various, obvious aspects all without departing from the invention. Accordingly, the drawings and descriptions will be regarded as illustrative in nature and not as restrictive.

In order to achieve one, some or all of the aforementioned objects or other objects, the present invention provides an ink jet printhead control circuit, which comprises a nozzle firing circuit and a nozzle firing control circuit. The nozzle firing circuit comprises a first switch and a heating resistor, wherein the first switch and the heating resistor are coupled in series between a power voltage level and a predetermined voltage level. The nozzle firing control circuit is coupled to the nozzle firing circuit to receive a selection signal and an address signal. When the address signal and the selection signal are enabled, the nozzle firing circuit is controlled to apply the power voltage level (when the power voltage level is at a high voltage level) to turn on the first switch, so that a current flows through the heating resistor. In one embodiment, the predetermined voltage level is a ground voltage level.

According to the ink jet printhead control circuit of the preferred embodiment of the present invention, the first switch comprises a control terminal, and the nozzle firing control circuit comprises a second switch and a third switch. The second switch has a first terminal coupled to the power voltage level, and a second terminal coupled to the control terminal of the first switch. The third switch has a first terminal for receiving the selection signal, a second terminal coupled to the control terminal of the second switch, and a control terminal for receiving the address signal. When the address signal is enabled, the third switch is turned on.

According to the ink jet printhead control circuit of the preferred embodiment of the present invention, the nozzle firing control circuit further comprises a first impedance element and a second impedance element. The first impedance element has a terminal coupled to the control terminal of the first switch and the other terminal coupled to the predetermined voltage level. The second impedance element has a terminal coupled to the control terminal of the second switch and the other end coupled to the predetermined voltage level. In a further embodiment, each of the first impedance element and the second impedance element respectively comprises a resistor.

According to the ink jet printhead control circuit of the preferred embodiment of the present invention, the nozzle firing control circuit further comprises a fourth switch, a voltage dividing element, and a fifth switch. The fourth switch has a first terminal coupled to the control terminal of the first switch, and a second terminal coupled to the predetermined voltage level. The voltage dividing element has an input terminal for receiving the selection signal, and an output terminal coupled to the control terminal of the fourth switch, and is used to output a signal by dividing the voltage level of the selection signal. The fifth switch has a first terminal coupled to the output terminal of the voltage dividing element, a second terminal coupled to the predetermined voltage level, and a control terminal for receiving the address signal.

According to the ink jet printhead control circuit of the preferred embodiment of the present invention, the voltage dividing element comprises a third impedance element and a fourth impedance element. The third impedance element has a terminal which is the input terminal of the voltage dividing element, and the other terminal which is the output terminal of the voltage dividing element. The fourth impedance element has a terminal coupled to the output terminal of the voltage dividing element and the other terminal coupled to the predetermined voltage level. In a further embodiment, the third impedance element comprises a resistor, a sixth switch, and a seventh switch, wherein the resistor has one terminal for receiving the selection signal. The sixth switch has a first terminal for receiving the selection signal, a control terminal coupled to the other terminal of the resistor, and a second terminal coupled to the fourth impedance element. The seventh switch has a first terminal coupled to the other terminal of the resistor, a second terminal coupled to the predetermined voltage level, and a control terminal for receiving the address signal. In another further embodiment, each of the third impedance element and fourth impedance element respectively comprises a resistor.

According to the ink jet printhead control circuit of the preferred embodiment of the present invention, the nozzle firing control circuit further comprises a fifth impedance element. The fifth impedance element has a terminal coupled to the control terminal of the fifth switch and the other terminal coupled to the predetermined voltage level. In a further embodiment, the fifth impedance element comprises a resistor.

According to the ink jet printhead control circuit of the preferred embodiment of the present invention, the ink jet printhead control circuit further comprises a disable control circuit. The disable control circuit is coupled to the first switch for receiving the selection signal. When the selection signal is disabled, the first switch is controlled to be turned off. In a further embodiment, the first switch comprises a control terminal, and the disable control circuit comprises an eighth switch, a ninth switch, and a sixth impedance element. The eighth switch has a first terminal coupled to the control terminal of the first switch, and a second terminal coupled to the predetermined voltage level. The ninth switch has a first terminal coupled to the control terminal of the eighth switch, a second terminal coupled to the predetermined voltage level, and a control terminal for receiving the selection signal. The sixth impedance element has a terminal coupled to the power voltage level, and the other terminal coupled to the first terminal of the ninth switch. In a further embodiment, the sixth impedance element is a transistor having a drain and a gate coupled to the power voltage level and a source coupled to the first terminal of the ninth switch.

According to the ink jet printhead control circuit of the preferred embodiment of the present invention, the first switch comprises a first terminal coupled to the power voltage level, a second terminal coupled to the heating resistor, and a control terminal, wherein one terminal of the heating resistor is coupled to the second terminal of the first switch and the other terminal of the heating resistor is coupled to the predetermined voltage level. In another embodiment, the first switch comprises a first terminal, a second terminal and a control terminal, wherein the first terminal is coupled to the predetermined voltage level, the second terminal coupled to the heating resistor, and one terminal of the heating resistor is coupled to the second terminal of the first switch and the other terminal of the heating resistor is coupled to the power voltage level. In the embodiment, the predetermined voltage level is grounded or a ground voltage level.

In the prior art, the address signal is used to drive the heating resistor (i.e. to control the status of the switch of the nozzle firing circuit), and thus the address signal requires a larger driving force, and ink jetting delay may occur. In comparison, the present invention adopts the power voltage level to turn on the switch of the nozzle firing circuit, and then to drive the heating resistor, thus achieving the purpose of jetting ink. Furthermore, the delay time can be reduced, and the address signal output from the printer can drive the nozzle firing circuit with a small driving force. In addition to reducing the ink jetting delay, increasing the drive level, and enhancing the ink jet performance, the present invention can also improve the printing quality of ink jet printers.

In order to make the aforementioned and other objectives, features and advantages of the present invention comprehensible, preferred embodiments accompanied with figures are described in detail below.

### BRIEF DESCRIPTION OF THE DRAWINGS

FIG. 1 is a drive circuit of an ink jet printer of U.S. Pat. No. 6,299,292.

FIG. 2 is a drive circuit of the ink jet printer of U.S. Pat. No. 5,867,183.

FIG. 3A is a schematic circuit block diagram of the ink jet printhead control circuit according to the ink jet printhead control circuit of an embodiment of the present invention.

FIGS. 3B˜3D are schematic circuit block diagrams of the ink jet printhead control circuit according to the ink jet printhead control circuit of another embodiment of the present invention.

FIGS. 4A and 4B are circuit diagrams of the ink jet printhead control circuit implemented according to the embodiment of FIG. 3A of the present invention.

FIGS. 5A and 5B are circuit diagrams of the ink jet printhead control circuit implemented according to the embodiment of FIGS. 4A and 4B of the present invention, respectively.

FIGS. 5C and 5D are circuit diagrams of the ink jet printhead control circuit implemented according to the embodiment of FIGS. 5A and 5B of the present invention, respectively.

FIGS. 6A and 6B are another circuit diagrams of the ink jet printhead control circuit implemented according to the embodiment of FIG. 3A of the present invention.

FIGS. 6C and 6D are circuit diagrams of the ink jet printhead control circuit implemented according to the embodiment of FIGS. 6A and 6B of the present invention, respectively.

FIGS. 7A and 7B are another circuit diagrams of the ink jet printhead control circuit implemented according to the embodiment of FIG. 3A of the present invention.

FIGS. 7C and 7D are circuit diagrams of the ink jet printhead control circuit implemented according to the embodiment of FIGS. 7A and 7B of the present invention, respectively.

FIGS. 8A and 8B are another circuit diagrams of the ink jet printhead control circuit implemented according to the embodiment of FIG. 3A of the present invention.

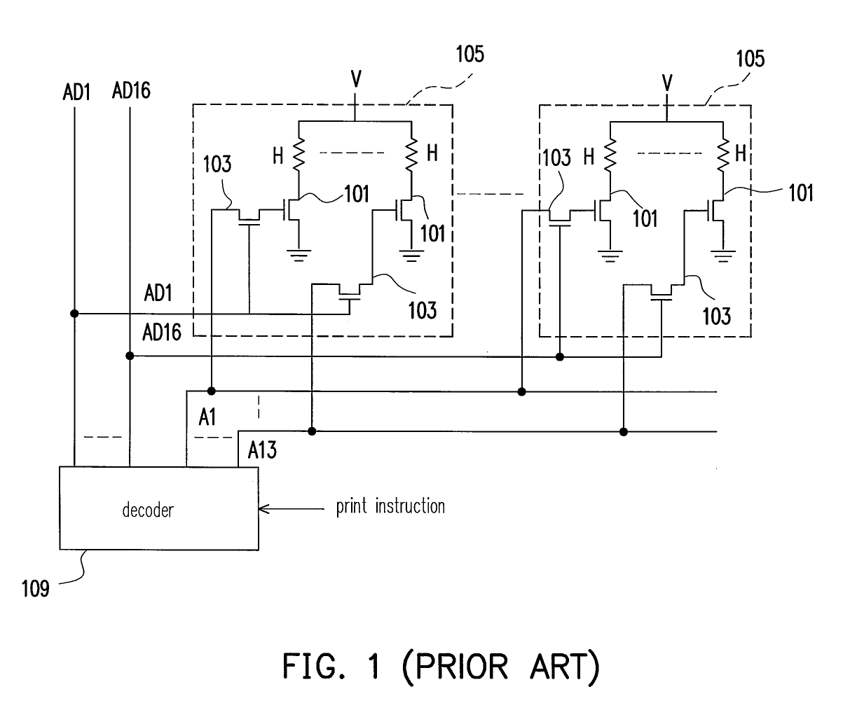

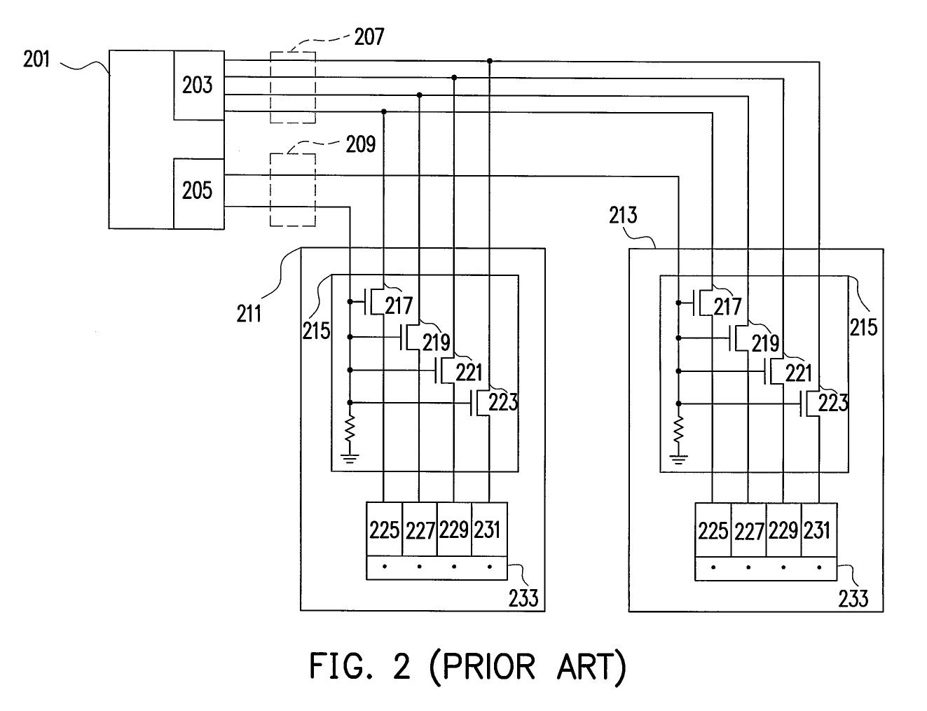

### DESCRIPTION OF EMBODIMENTS

The circuit architecture of the prior art adopts the address signal to drive the heating resistor (i.e. to control the status of the switch of the nozzle firing circuit), and thus the address signal requires a larger driving force to drive the nozzle firing circuit. Moreover, a field-effect transistor is added between the address signal and the heating resistor of the firing circuit to function as a control switch. However, the transistor has a body effect, such that the drive level received by the firing circuit is relatively low, thus causing an ink-jetting delay. The present invention provides an ink jet printhead control circuit for reducing the ink jetting delay, increasing the drive level, and improving the ink-jet performance. The present invention is illustrated with embodiments herein blow.

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. As such, the directional terminology is used for purposes of illustration and is in no way limiting.

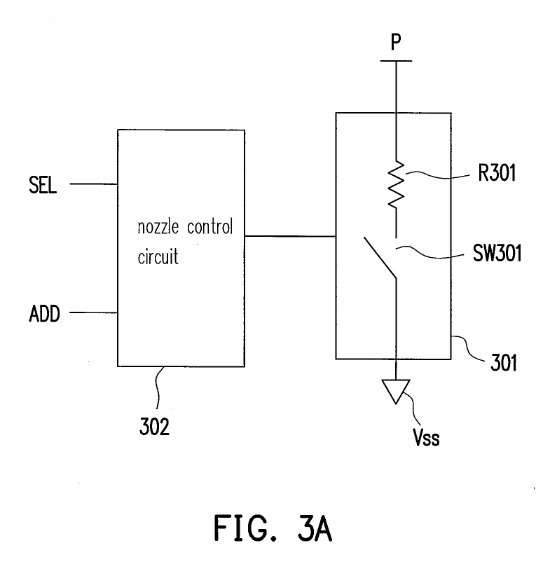

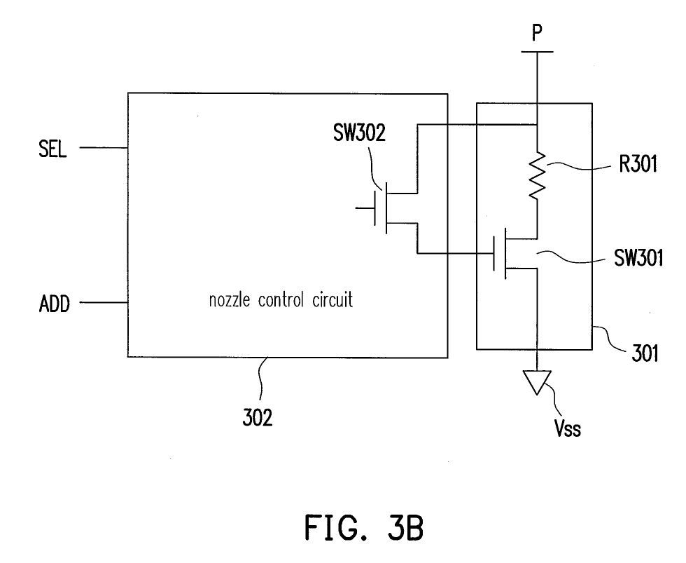

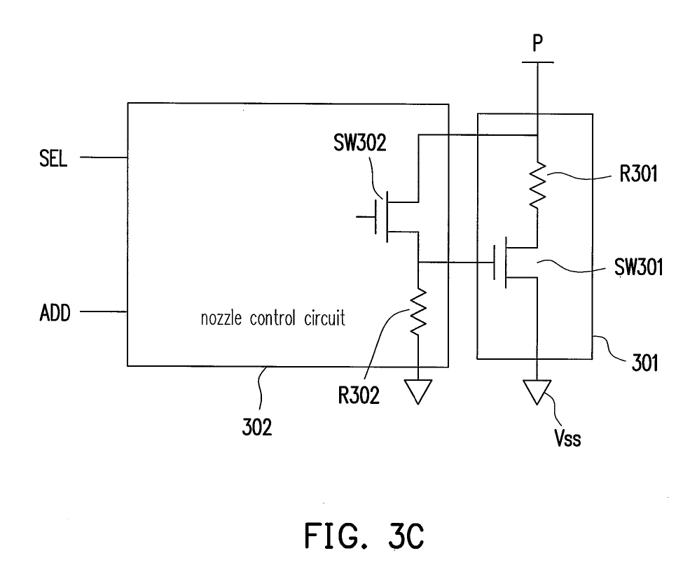

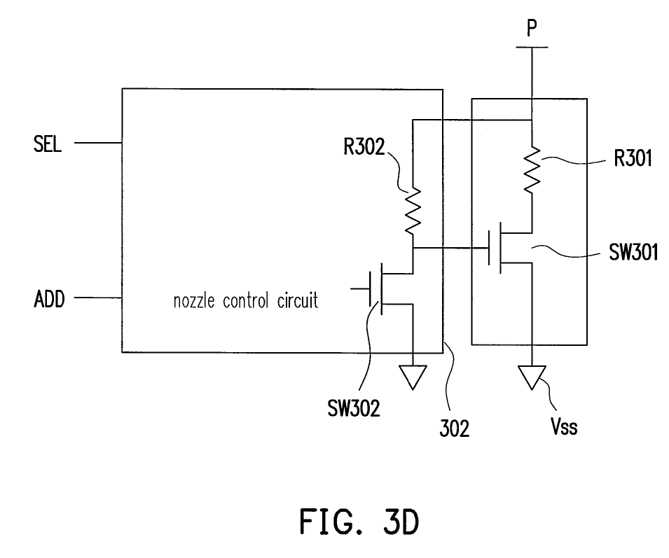

FIG. 3A is a schematic circuit block diagram of the ink jet printhead control circuit according to an embodiment of the present invention. Generally, an ink jet printhead ink output unit (e.g., ink cartridge with printhead chip, or printhead chip itself) comprises a plurality of sets of ink jet printhead control circuits. Referring to FIG. 3A, the circuit comprises at least one nozzle firing circuit 301 and a nozzle firing control circuit 302. The nozzle firing circuit 301 at least comprises a switch SW301 and a heating resistor R301, wherein the switch SW301 and the heating resistor R301 are coupled in series between the power voltage level P and the predetermined voltage level Vss. In this embodiment, for example, the heating resistor is coupled to the power voltage level P, and the switch SW301 is coupled between the heating resistor and the predetermined voltage level Vss. The nozzle firing control circuit 302 is electrically coupled (“electrically coupled” or “electrically couple(s)” or “coupled” or “couple(s)” is referred to as “coupled” or “couple(s)” in the present invention) to the nozzle firing circuit 301, and receives a selection signal SEL and an address signal ADD. When the address signal ADD and the selection signal SEL are enabled, the nozzle firing circuit 301 is controlled to apply the power voltage level P (when the power voltage level is at a high voltage level) to turn on the switch SW301, so as to drive the heating resistor R301 to jet ink. The address signal and the selection signal have a high voltage level and a low voltage level. It is known to the person having ordinary skill in the art that the selection signal is used to select desired one or several of the printhead ink output units, and the address signal is used to selectively enable the specific group of nozzle firing circuits 301 that corresponds to the address signal.

FIGS. 3B˜3D are several examples of applying the power voltage level P to turn on the switch SW301. In the following embodiments, N-type transistors are taken as an example to illustrate all switches, and it is apparent to those of ordinary skill in the art that in additional to the N-type transistors, P-type transistors, multiplexers, transmission gates, relays, etc. can also be implemented as the switches, and thus the present invention is not limited herein. Referring to FIG. 3B, for example, a switch SW302 is electrically coupled between the power voltage level P and the switch SW301. When the address signal ADD and the selection signal SEL are enabled, the switch SW302 is turned on, such that the control terminal (i.e., the gate of the N-type transistor) of the switch SW301 directly receives the power voltage level P, and an effect of rapid conduction can be obtained.

The difference between FIG. 3C and FIG. 3B lies in that an extra impedance element R302 of FIG. 3C is coupled in series under the switch SW302 to the predetermined voltage level Vss, as observed from the figures. FIG. 3D shows another embodiment of applying the power voltage level P to turn on the switch SW301. In FIG. 3D, the power voltage level P is coupled to the control terminal (i.e., the gate of the N-type transistor) of the switch SW301 via the impedance element R302. Additionally, the switch SW302 is further coupled in series under the impedance element R302. When the address signal ADD or the selection signal SEL is not enabled, the switch SW302 is turned on, and when the address signal ADD and the selection signal SEL are enabled, the switch SW302 is controlled to be turned off (non-conducted), such that the control terminal of the switch SW301, i.e., the gate of the N-type transistor, receives the power voltage level P, thus achieving the effect of rapid conduction.

It should be noted that some possible forms of the ink jet printhead control circuit are illustrated in the above embodiments. However, it is apparent to those of ordinary skill in the art that the designs of the nozzle firing circuit 301 and the nozzle firing control circuit 302 of various manufacturers are different, and thus the application of the present invention is not limited to the above. In other words, the present invention can be summarized as: The switch SW301 of the nozzle firing circuit 301 and the heating resistor R301 are coupled in series between the power voltage level P and the predetermined voltage level Vss, and when the address signal ADD and the selection signal SEL are enabled, the nozzle firing control circuit 302 controls the nozzle firing circuit 301 to apply the power voltage level P (when the power voltage level is at a high voltage level) to turn on the switch SW301, thus driving the heating resistor R301 to jet ink.

Hereinafter, several embodiments are illustrated for those of ordinary skill in the art to implement the present invention.

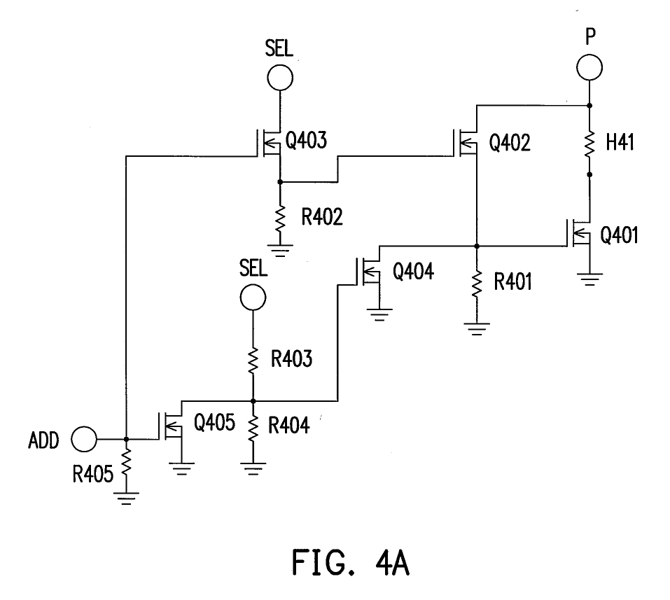

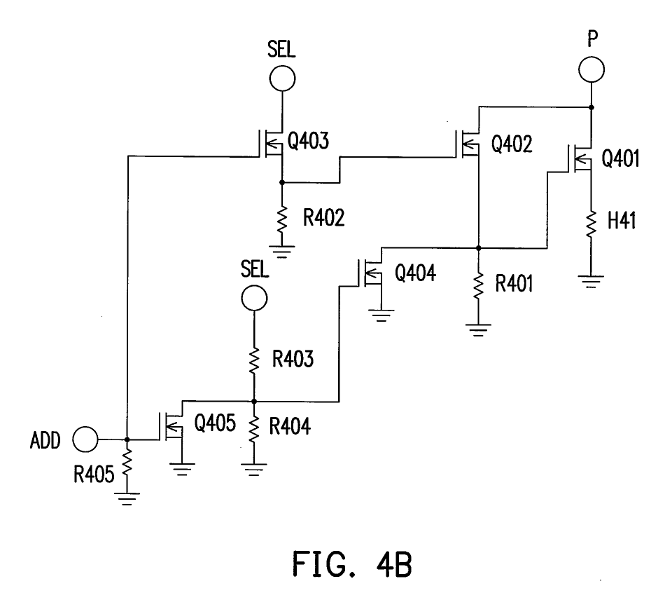

FIGS. 4A and 4B are circuit diagrams of the ink jet printhead control circuit according to the embodiment of FIG. 3A of the present invention. Referring to FIG. 4A, the nozzle firing circuit 301 of the circuit employs a transistor Q401 as the switch SW301 and a resistor H41 as the heating resistor R301. The nozzle firing control circuit 302 of the circuit employs, for example, transistors Q402, Q403, Q404, and Q405 and resistors R401, R402, R403, R404, and R405, and the coupling relationship thereof is shown in FIG. 4A.

When the selection signal SEL and address signal ADD are not enabled (the enabled state is assumed to be logic 1 in this embodiment), the transistor Q402 is turned off (non-conducted), and the transistor Q401 is also turned off, and thus no current passes through the heating resistor H41. When the selection signal SEL is enabled and the address signal ADD is not enabled, the printer selects a certain ink cartridge having the ink jet printhead control circuit, however, the specific ink jet printhead control circuit in the selected certain ink cartridge is not selected or addressed (as an ink cartridge may contain a plurality of sets of ink jet printhead control circuits which are respectively coupled to the corresponding address signal ADD). At this condition, the transistors Q403 and Q405 are turned off, such that the Q402 is turned off. When the selection signal SEL is enabled, the Q404 is turned on, and the gate of the Q401 is drawn to a low voltage level to be turned off, such that the nozzle firing circuit does not jet ink. When the selection signal SEL is not enabled and the address signal ADD is enabled, the printer does not select the ink cartridge having the ink jet printhead control circuit of this embodiment. At this condition, the transistors Q402 and Q404 are turned off, and the transistor Q401 is also turned off, such that no current passes through the heating resistor H41. When the selection signal SEL and the address signal ADD are enabled, the transistors Q403 and Q405 are turned on, and the transistor Q402 receives the selection signal SEL transmitted from the transistor Q403 to be turned on. The transistor Q404 is turned off as the voltage dividing point of the selection signal is drawn to a low voltage level by the transistor Q405. Since Q402 is turned on, the power voltage level P flows into the gate of the transistor Q401 (when the power voltage level P is at a high voltage level). Therefore, the transistor Q401 is quickly turned on, such that a current passes through the heating resistor H41 to heat the ink to jet ink. It should be noted that when the selection signal SEL and the address signal ADD are enabled and the power voltage level P is at a low voltage level (and the power supplied to the nozzle firing circuit is not sufficient), the gate of the transistor Q401 is not turned on, and thus no current passes through the heating resistor H41 to heat the ink to jet ink.

In this embodiment, the operational voltage when the selection signal SEL and the address signal ADD are enabled and the operational voltage when the power voltage level P is at a high voltage level are about 8V-20V, and the preferred operation voltage is about 10V-13V. The applicable resistance of the R403 is in a range of about 1 k˜50 kΩ, and the preferred resistance is in a range of about 10 k˜20 kΩ. The applicable resistance of the R401, R402, R404, and R405 is in a range of about 5 k˜250 kΩ, and the preferred resistance is in a range of about 35 k˜100 kΩ. However, the present invention is not limited to the above numeral values.

Similarly, the difference between FIG. 4B and FIG. 4A lies in that the transistor Q401 of the FIG. 4B is coupled between the heating resistor H41 and the power voltage level P. It is apparent to those of ordinary skill in the art that the operation thereof is the same as that described above, and will not be described herein again.

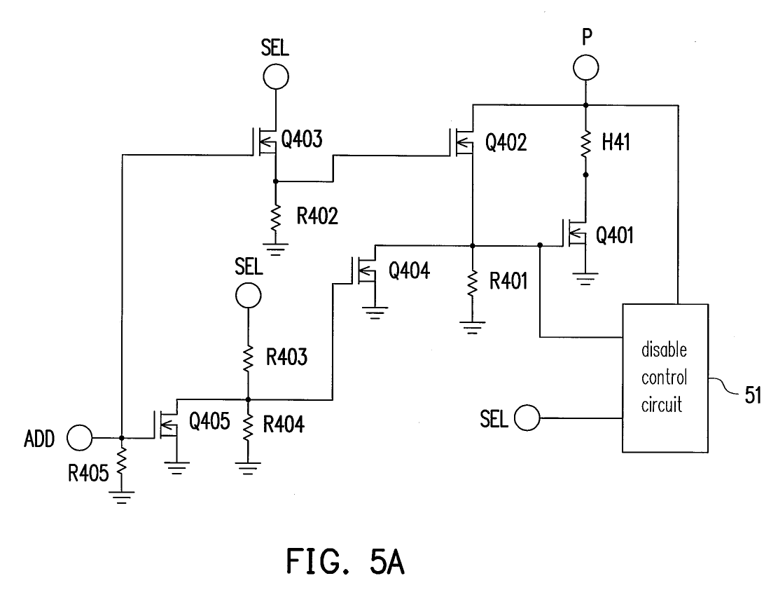

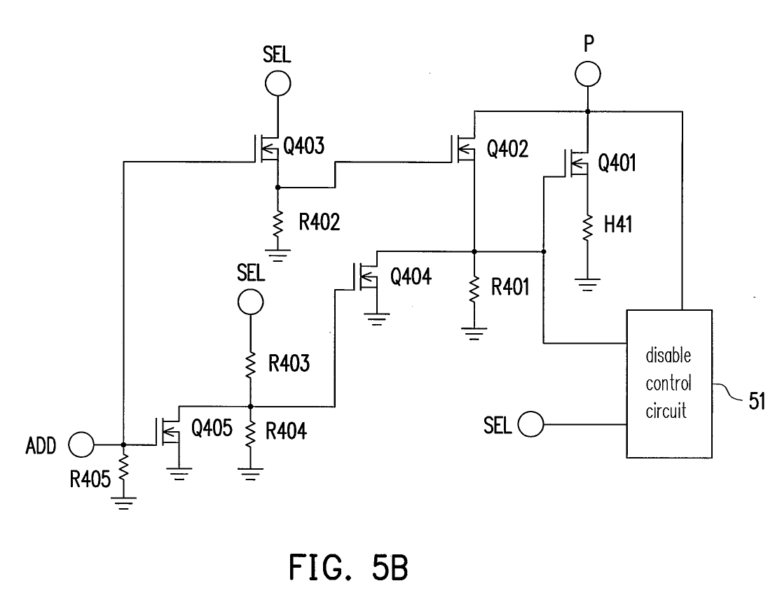

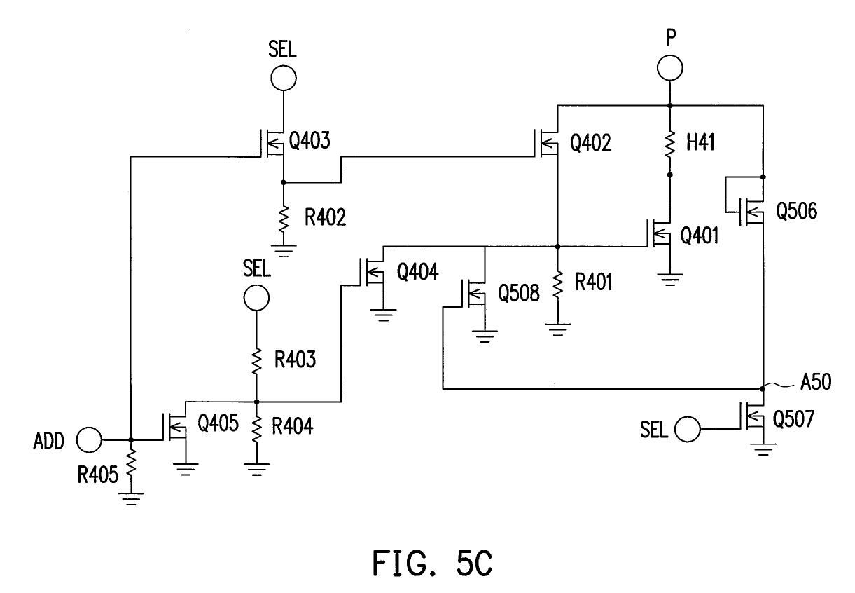

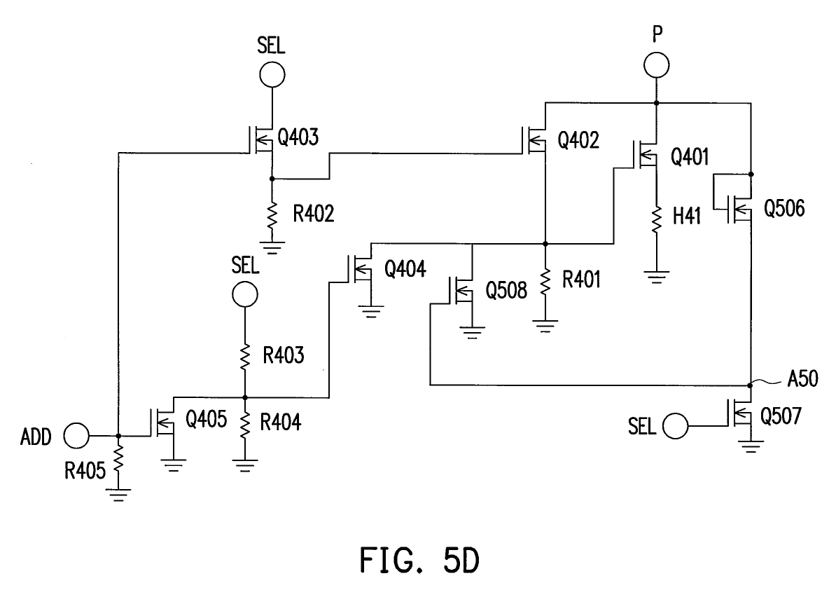

FIGS. 5A and 5B are circuit diagrams of the ink jet printhead control circuit implemented according to the embodiment of FIGS. 4A and 4B of the present invention, respectively. Comparing FIG. 5A, FIG. 5B and FIG. 4A, FIG. 4B respectively, different from the circuit of FIGS. 4A and 4B, the circuits of FIGS. 5A and 5B further has a disable control circuit 51 coupled to the first switch SW301 for receiving the selection signal SEL. When the selection signal SEL is disabled, the first switch SW301 (transistor Q401) is controlled to be turned off.

FIGS. 5C and 5D are circuit diagrams of the ink jet printhead control circuit implemented according to the embodiment of FIGS. 5A and 5B of the present invention, respectively. In the circuits of FIG. 5C and FIG. 5D, a disable control circuit 51 employs, for example, transistors Q506, Q507, and Q508, wherein the transistor Q506 is a transistor using an NMOS. When the selection signal SEL is enabled (the enabled state is assumed to be logic 1 in this embodiment), the transistor Q507 is turned on and the voltage level at the node A50 is drawn to a low voltage level, such that the transistor Q508 is turned off. When the selection signal SEL is disabled, the transistor Q507 is turned off and the voltage level at the node A50 is a high voltage level (when the power voltage level P is a high voltage level), such that the transistor Q508 is turned on. Since the Q508 is turned on, the gate of the Q401 remains at a low voltage level, and thus the transistor Q401 can be protected from being interfered by noise and the problem of the ink cartridge jetting ink due to noise can be overcome.

With reference to the above mentioned embodiments, it is apparent to those of ordinary skill in the art that the transistor Q506 can be equivalently replaced by a resistor, and the present invention is not limited to this.

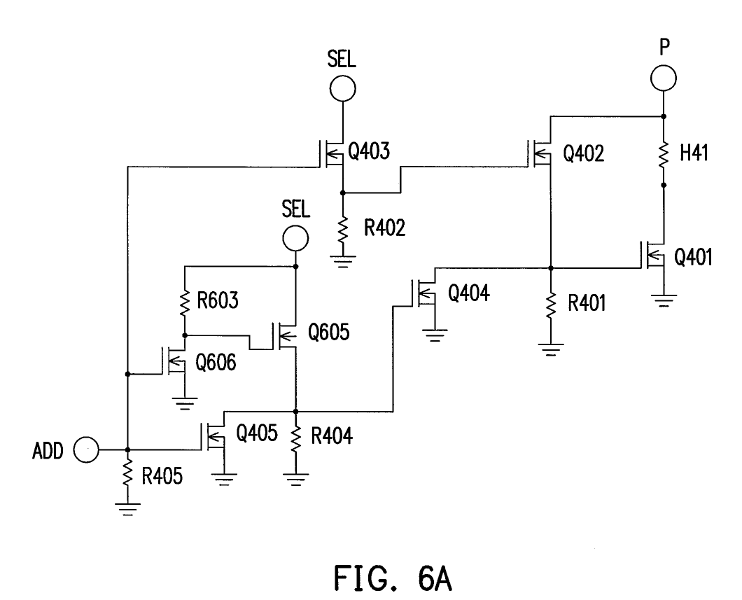

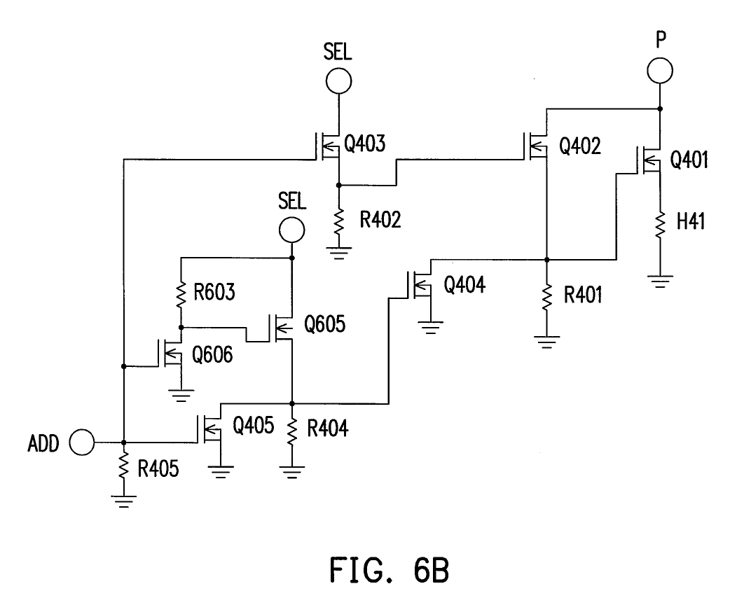

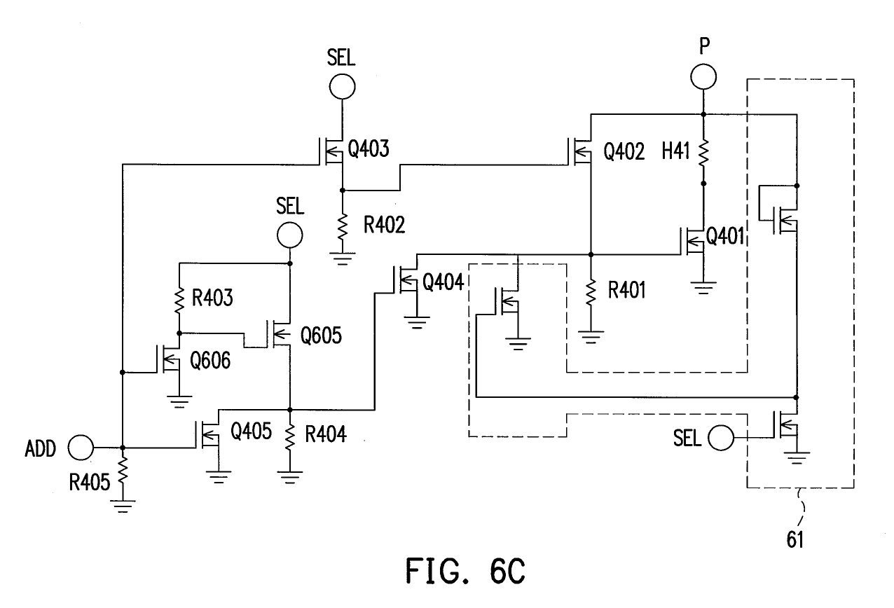

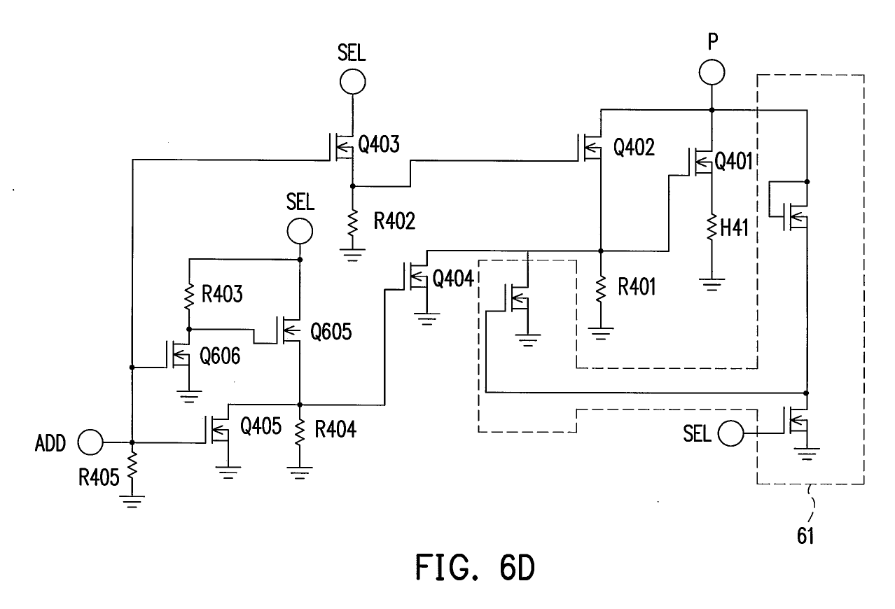

FIGS. 6A and 6B are another circuit diagrams of the ink jet printhead control circuit implemented according to the embodiment of FIG. 3A of the present invention. Comparing FIG. 6A and FIG. 4A, the difference between the circuits of FIG. 6A and FIG. 4A lies in that the resistor R403 of FIG. 4A is replaced by transistors Q605, Q606 and resistor R603 in FIG. 6A.

When the selection signal SEL is enabled and the address signal ADD is not enabled, the gates of the transistors Q606, Q403, Q402 are at a logic low voltage level and thus turned off. The gate of the transistor Q605 receives the high voltage level of the selection signal through the resistor R603, such that the transistor Q605 is turned on. Thus, the transistor Q404 is turned on, and the transistor Q401 is turned off. When the selection signal SEL is not enabled and the address signal ADD is enabled, the transistors Q403, Q405, Q606 are turned on, the gates of the transistor Q402 and the transistor Q404 are turned off due to the logic low voltage level, and the transistor 401 is also turned off. When the selection signal SEL and the address signal ADD are enabled, the transistors Q403, Q606, and Q405 are turned on, and the transistors Q605 and Q404 are turned off. The gate of the transistor Q402 receives the high voltage level of the selection signal SEL and thus is turned on. When the power voltage level P is at a high voltage level, the power voltage level P is transmitted to the gate of the transistor Q401 through the transistor Q402, such that the transistor Q401 is turned on. Since the transistor Q401 is turned on, a current flows from the power voltage level P through the heating resistor H41 to make the nozzle firing circuit jet ink.

In this embodiment, the operational voltage when the selection signal SEL and the address signal ADD are enabled and the operational voltage when the power voltage level P is at a high voltage level are about 8V-20V, and the preferred operation voltage is about 10V-13V. The applicable resistance of R401, R402, R404, and R405 is in a range of about 5 k˜250 kΩ, and preferably about 35 k˜100 kΩ. The applicable resistance of R603 is in a range of about 100˜10 k Ω, and preferably about 100˜1 kΩ. However, the present invention is not limited to the above numeral values.

Referring to FIG. 6B, the difference between the circuits of FIG. 6A and FIG. 6B lies in that the transistor Q401 of FIG. 6B is coupled between the heating resistor H41 and the power voltage level P. It is apparent to those of ordinary skill in the art that the operation thereof is also the same as that described above, and will not be described herein again.

FIGS. 6C and 6D are circuit diagrams of the ink jet printhead control circuit implemented according to the embodiment of FIGS. 6A and 6B of the present invention, respectively. Comparing FIG. 6C, FIG. 6D and FIG. 6A, FIG. 6B respectively, different from FIG. 6A and FIG. 6B, the circuits of FIG. 6C and FIG. 6D further comprises a disable control circuit 61. The implementation of the disable control circuit 61 is the same as that of FIG. 5C and FIG. 5D, and the operation thereof is also the same, and will not be described herein again.

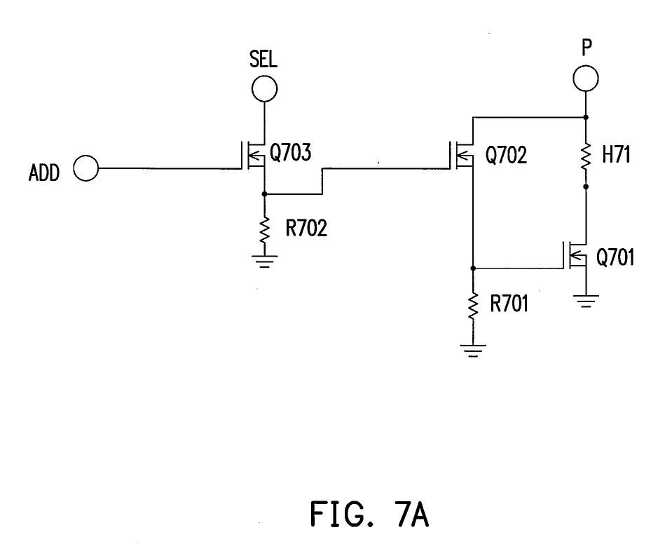

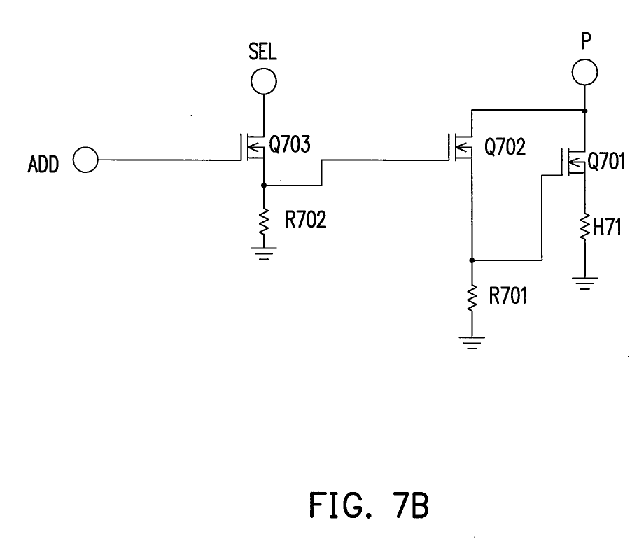

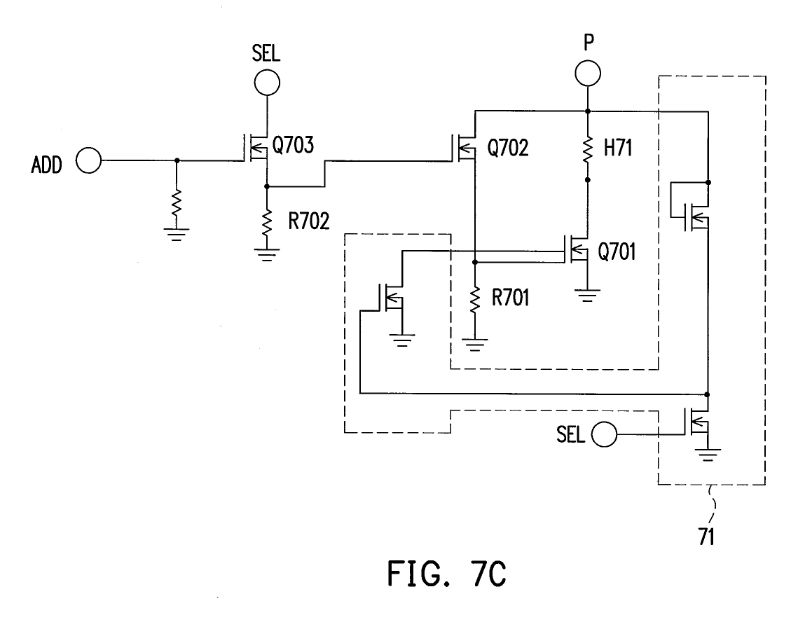

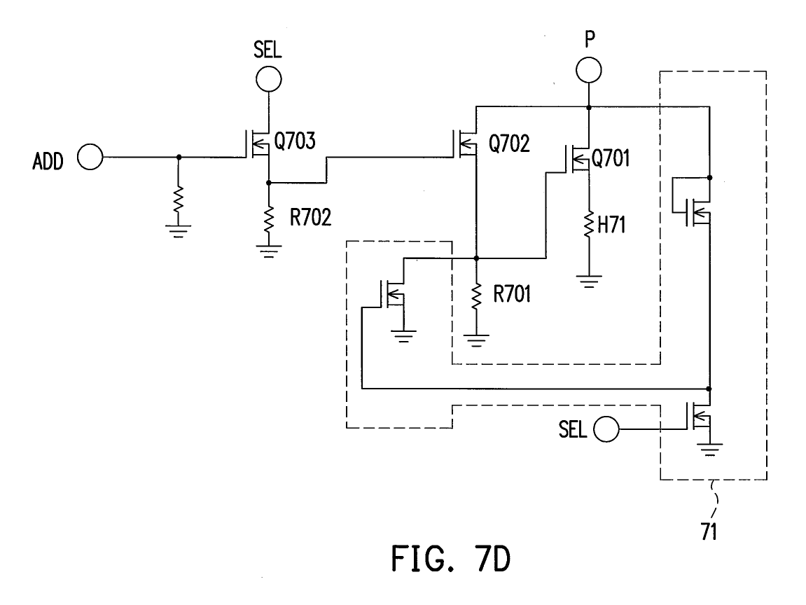

FIGS. 7A and 7B are another two circuit diagrams of the ink jet printhead control circuit implemented according to the embodiment of FIG. 3A of the present invention. Referring to FIG. 7A, in this circuit, the nozzle firing circuit 301 is implemented with a heating resistor H71 and a transistor Q701; the nozzle firing control circuit 302 is implemented with transistors Q702, Q703 and resistors R701, R702. When the selection signal SEL is enabled and the address signal is not enabled, the transistor Q703 is turned off such that the Q702 is turned off, and thus the transistor Q701 is turned off, and the nozzle firing circuit 301 does not jet ink. When the selection signal SEL and the address signal are enabled, the transistor Q703 is turned on, the selection signal SEL turns on the transistor Q702 through the transistor Q703, and the power voltage level P (when the power voltage level is at a high voltage level) is transmitted to the gate of the transistor Q701 through the transistor Q702 to turn on the transistor Q701, such that the nozzle firing circuit 301 can heat the ink to jet ink.

In this embodiment, the operational voltage when the selection signal SEL and the address signal ADD are enabled and the operational voltage when the power voltage level P is at a high voltage level are about 8V-20V, and the preferred operation voltage is about 10V-13V. The applicable resistance of R701 and R702 is in a range of about 5 k˜250 kΩ, and preferably about 35 k˜100 kΩ. However, the present invention is not limited to this.

The difference between the circuit of FIG. 7B and that of FIG. 7A lies in that the transistor Q701 of FIG. 7B is coupled between the heating resistor H71 and the power voltage level P. It is apparent to those of ordinary skill in the art that the operation thereof is also the same as that described above, and will not be described herein again.

FIGS. 7C and 7D are circuit diagrams of the ink jet printhead control circuit implemented according to the embodiment of FIG. 7A and FIG. 7B of the present invention, respectively. Comparing FIG. 7C, FIG. 7D and FIG. 7A, FIG. 7B respectively, different from FIG. 7A and FIG. 7B, the circuits of FIG. 7C and FIG. 7D further comprises a disable control circuit 71. The implementation of the disable control circuit 71 is the same as that of FIG. 5C and FIG. 5D, and the operation thereof is also the same, and will not be described herein.

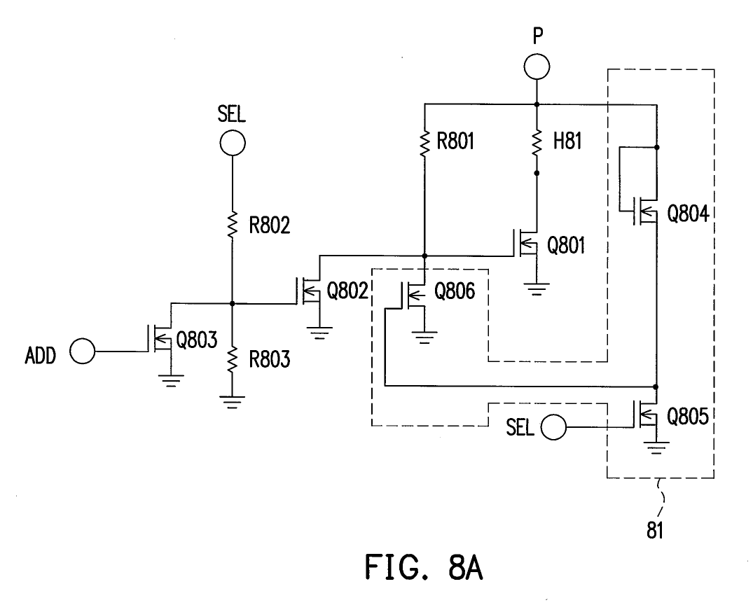

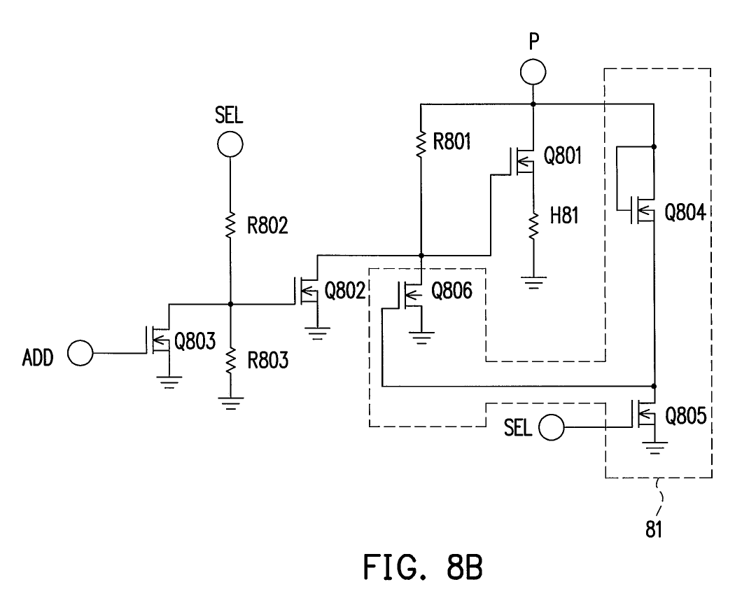

FIGS. 8A and 8B are another two circuit diagrams of the ink jet printhead control circuit implemented according to the embodiment of FIG. 3A of the present invention. Referring to FIG. 8A, in this circuit, the nozzle firing circuit 301 is implemented with a heating resistor H81 and a transistor Q801; the nozzle firing control circuit 302 is implemented with transistors Q802, Q803, resistors R801, R802, R803, and a disable control circuit 81, wherein the disable control circuit 81 is implemented with transistors Q804, Q805, and Q806.

When the selection signal SEL and the address signal ADD are not enabled (the enabled state is assumed to be logic 1 in this embodiment), the transistors Q802, Q803, and Q805 are turned off. When the power voltage level P is at a high voltage level, the transistor Q806 is turned on such that the transistor Q801 is turned off, and thus no current passes through the heating resistor H81. When the selection signal SEL is enabled and the address signal ADD is not enabled, the transistor Q805 is turned on such that the transistor Q806 is turned off. The selection signal SEL, after being subjected to a voltage division by resistors R802 and R803, flows into the gate of the transistor Q802, so as to turn on the transistor Q802. Therefore, the transistor Q801 is not turned on, and the nozzle firing circuit does not jet ink. When the selection signal SEL and the address signal ADD are enabled, the transistor Q803 is turned on such that the transistor Q802 is turned off. The power voltage level P (at a high voltage level) directly flows into the gate of the transistor Q401 through the resistor R801, such that the transistor Q401 is quickly turned on and thus a current passes through the heating resistor H81 to heat the ink to jet ink.

In this embodiment, the operational voltage when the selection signal SEL and the address signal ADD are enabled and the operational voltage when the power voltage level P is at a high voltage level are about 8V-20V, and the preferred operation voltage is about 10V-13V. The applicable resistance of R801 and R802 is in a range of about 1 k˜50 kΩ, and preferably about 10 k˜20 kΩ. The applicable resistance of R803 is in a range of about 5 k˜250 kΩ, and preferably about 35 k˜100 kΩ. However, the present invention is not limited to this.

The difference between the circuits of FIG. 8B and FIG. 8A lies in that the transistor Q801 of FIG. 8B is coupled between the heating resistor H81 and the power voltage level P. It is apparent to those of ordinary skill in the art that the operation thereof is also the same as that described above, and will not be described herein again.

The present invention adopts the power voltage level P to turn on the switch SW301 of the nozzle firing circuit 301, and then drive the heating resistor R301, so as to heat the ink to jet ink. The driving force of power voltage level P is larger than that of the address signal ADD, and is quicker, so the delay time can be reduced, and the address signal output by the printer can also drive the nozzle firing circuit with a smaller driving force. In addition to reducing the ink jetting delay, increasing the drive level, and improving the ink-jet performance, the present invention can further improve the printing quality of the ink jet printer.

The foregoing description of the preferred embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims. These claims may refer to “an” element or “a first” element or the equivalent thereof. Such claims should be understood to include incorporation of one or more such elements, neither requiring nor excluding two or more such elements.

What is claimed is:

1. An ink jet printhead control circuit, comprising:
a nozzle firing circuit coupled to a power voltage level, comprising a first switch and a heating resistor, wherein the first switch and the heating resistor are coupled in series between the power voltage level and a predetermined voltage level; and
a nozzle firing control circuit coupled to the nozzle firing circuit for receiving a selection signal and an address signal, wherein when the address signal and the selection signal are enabled, the nozzle firing circuit is controlled to apply the power voltage level to turn on the first switch, so that a current flows through the heating resistor.

2. The ink jet printhead control circuit as claimed in claim 1, wherein the first switch comprises a control terminal, and the nozzle firing control circuit comprises:
a second switch, comprising a first terminal coupled to the power voltage level, a second terminal coupled to the control terminal of the first switch, and a control terminal; and
a third switch, comprising a first terminal for receiving the selection signal, a second terminal coupled to the control terminal of the second switch, and a control terminal for receiving the address signal, wherein when the address signal is enabled, the third switch is turned on.

3. The ink jet printhead control circuit as claimed in claim 2, wherein the nozzle firing control circuit further comprises:
a first impedance element, having a terminal coupled to the control terminal of the first switch and the other terminal coupled to the predetermined voltage level; and
a second impedance element, having a terminal coupled to the control terminal of the second switch and the other terminal coupled to the predetermined voltage level.

4. The ink jet printhead control circuit as claimed in claim 3, wherein each of the first impedance element and the second impedance element respectively comprises a resistor.

5. The ink jet printhead control circuit as claimed in claim 2, wherein the nozzle firing control circuit further comprises:
a fourth switch, comprising a first terminal coupled to the control terminal of the first switch, a second terminal coupled to the predetermined voltage level, and a control terminal; and
a voltage dividing element, comprising an input terminal for receiving the selection signal and an output terminal coupled to the control terminal of the fourth switch, and being used for dividing the voltage level of the selection signal and outputting it; and
a fifth switch, comprising a first terminal coupled to the output terminal of the voltage dividing element, a second terminal coupled to the predetermined voltage level, and a control terminal for receiving the address signal.

6. The ink jet printhead control circuit as claimed in claim 5, wherein the voltage dividing element comprises:
a third impedance element having a terminal which is the input terminal of the voltage dividing element and the other terminal which is the output terminal of the voltage dividing element; and
a fourth impedance element having a terminal coupled to the output terminal of the voltage dividing element and the other terminal coupled to the predetermined voltage level.

7. The ink jet printhead control circuit as claimed in claim 6, wherein the third impedance element comprises:
a resistor having a terminal for receiving the selection signal;
a sixth switch, comprising a first terminal for receiving the selection signal, a control terminal coupled to the other terminal of the resistor, and a second terminal coupled to the fourth impedance element; and
a seventh switch, comprising a first terminal coupled to the other terminal of the resistor, a second terminal coupled to the predetermined voltage level, and a control terminal for receiving the address signal.

8. The ink jet printhead control circuit as claimed in claim 6, wherein each of the third impedance element and the fourth impedance element respectively comprises a resistor.

9. The ink jet printhead control circuit as claimed in claim 5, wherein the nozzle firing control circuit further comprises:
a fifth impedance element, having a terminal coupled to the control terminal of the fifth switch and the other terminal coupled to the predetermined voltage level.

10. The ink jet printhead control circuit as claimed in claim 9, wherein the fifth impedance element comprises a resistor.

11. The ink jet printhead control circuit as claimed in claim 1, further comprising:
a disable control circuit coupled to the first switch, for receiving the selection signal, wherein when the selection signal is disabled, the first switch is controlled to be turned off.

12. The ink jet printhead control circuit as claimed in claim 11, wherein the first switch comprises a control terminal, and the disable control circuit comprises:
an eighth switch, comprising a first terminal coupled to the control terminal of the first switch, a second terminal coupled to the predetermined voltage level, and a control terminal;
a ninth switch, comprising a first terminal coupled to the control terminal of the eighth switch, a second terminal coupled to the predetermined voltage level, and a control terminal for receiving the selection signal; and
a sixth impedance element, having a terminal coupled to the power voltage level, and the other terminal coupled to the first terminal of the ninth switch.

13. The ink jet printhead control circuit as claimed in claim 12, wherein the sixth impedance element is a transistor which has a drain and a gate coupled to the power voltage level, and a source coupled to the first terminal of the ninth switch.

14. The ink jet printhead control circuit as claimed in claim 1, wherein the first switch comprises a first terminal coupled to the power voltage level, a second terminal coupled to the heating resistor, and a control terminal.

15. The ink jet printhead control circuit as claimed in claim 14, wherein the heating resistor has a terminal coupled to the second terminal of the first switch, and the other terminal coupled to the predetermined voltage level.

16. The ink jet printhead control circuit as claimed in claim 1, wherein the first switch comprises a first terminal coupled to the predetermined voltage level, a second terminal coupled to the heating resistor, and a control terminal.

17. The ink jet printhead control circuit as claimed in claim 16, wherein the heating resistor has a terminal coupled to the second terminal of the first switch, and the other terminal coupled to the power voltage level.

18. The ink jet printhead control circuit as claimed in claim 1, wherein the first switch comprises a control terminal, and the nozzle firing control circuit comprises:
a disable control circuit coupled to the control terminal of the first switch, for receiving the selection signal, wherein when the selection signal is disabled, the first switch is controlled to be turned off;
a first impedance element, having a terminal coupled to the control terminal of the first switch and the other terminal coupled to the power voltage level;
a second switch, comprising a first terminal coupled to the predetermined voltage level, a second terminal coupled to the control terminal of the first switch, and a control terminal; and
a voltage dividing element, comprising an input terminal for receiving a selection signal and an output terminal coupled to the control terminal of the second switch, for outputting the selection signal with the voltage divided through the output terminal of the voltage dividing element; and
a third switch, comprising a first terminal coupled to the output terminal of the voltage dividing element, a second terminal coupled to the predetermined voltage level, and a control terminal for receiving the address signal, wherein when the address signal is enabled, the third switch is turned on.

19. The ink jet printhead control circuit as claimed in claim 18, wherein the voltage dividing element further comprises:
a second impedance element, having a terminal for receiving the selection signal, and the other terminal coupled to the control terminal of the second switch; and
a third impedance element, having a terminal coupled to the control terminal of the second switch and the other terminal coupled to the predetermined voltage level.

20. The ink jet printhead control circuit as claimed in claim 19, wherein the disable control circuit comprises:
a fourth switch, comprising a first terminal coupled to the control terminal of the first switch, a second terminal coupled to the predetermined voltage level, and a control terminal;
a fifth switch, comprising a first terminal coupled to the control terminal of the fourth switch, a second terminal coupled to the predetermined voltage level, and a control terminal for receiving the selection signal; and
a fourth impedance element, having a terminal coupled to the power voltage level and the other terminal coupled to the first terminal of the fifth switch.

21. The ink jet printhead control circuit as claimed in claim 20, wherein the fourth impedance element is a transistor which has a drain and a gate coupled to the power voltage level and a source coupled to the first terminal of the fifth switch.

22. The ink jet printhead control circuit as claimed in claim 1, wherein the predetermined voltage level is a ground voltage level.

23. An ink jet printhead control circuit, comprising:
a nozzle firing circuit coupled to a power voltage level, comprising a first switch and a heating resistor, wherein the first switch and the heating resistor are coupled in series between the power voltage level and a ground voltage level; and
a nozzle firing control circuit coupled to the nozzle firing circuit for receiving a selection signal and an address signal, wherein when both of the address signal and the selection signal are enabled, and when the power voltage level is at a high voltage level, the power voltage level is applied to turn on the first switch, so that a current flows through the heating resistor.
